(19) United States
(12) Patent Application Publication
(10) Pub. No.: US 2009/0083128 A1
(43) Pub. Date: Mar. 26, 2009

(54) PREDICTED VARIABLE ANALYSIS BASED ON EVALUATION VARIABLES RELATING TO SITE SELECTION

(75) Inventor: Jason Michael Siegel, New York, NY (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Introspective Solutions, LLC, New York, NY (US)

(21) Appl. No.: 12/184,568

(22) Filed: Aug. 1, 2008

Related U.S. Application Data
(60) Provisional application No. 60/974,542, filed on Sep. 24, 2007.

(51) Int. Cl. G06Q 10/00

(52) U.S. Cl. 705/10

(57) ABSTRACT

Systems, methods and computer readable media that assist in evaluating the likelihood of success of a new business location. Information about existing business locations may be provided, which includes information about a predicted variable. Data may be collected from either third-party providers, publically available information, or the user that will represent the evaluation variables. A formula is generated that comprises evaluation variables and associated coefficients. The coefficients are determined based on a correlation between the evaluation variables and the predicted variable. Data is collected for a new business location or region in order to determine the value of the evaluation variables for the new business location or region. By applying the coefficients to the evaluation variable values for the new business location or region, an output value of the predicted variable is provided. The output value of the predicted variable may be used to evaluate the likelihood of success of the new business location or region.

### PRIORITY CLAIM

This application claims priority to provisional application 60/974542, filed Sep. 24, 2007, which is incorporated by reference in its entirety.

### BACKGROUND

Evaluating parameters relating to selecting a location or site, such as determining a new business location, often requires a large investment of both effort and capital. In addition, opening a new business location involves risk. For example, if the new business location is not successful, the effort and capital may be lost. In order to reduce such risk, those seeking to open a new business location may try to evaluate potential locations before committing the effort and capital necessary to open a new business location.

Currently, there are many difficulties in decision making about locations, such as determining where to open a new business location, including for example insufficient knowledge of potential locations, insufficient in-house expertise, and the like.

### SUMMARY

the present invention is not limited to the disclosed embodiments nor to solution of any or all of the above noted problems, nor are the disclosed embodiments limited to the example embodiments recited in the specification. Further, this summary is not meant to give an extensive overview or to identify critical elements of the disclosed embodiments.

Systems, methods and computer readable media may be provided that assist in evaluating the likelihood of success of a new business location. The disclosed embodiments may receive information about existing business locations. The information received may relate to a predicted variable for which values may be predicted for a new business location. For example, a user may provide annual sales information for a number of existing business locations (i.e., annual sales is the predicted variable). A predicted value for annual sales at a new business location may be provided by the disclosed embodiments. A likelihood of success of the new business location may be evaluated based on the predicted value of annual sales at the new business location.

The disclosed embodiments may collect information from either third-party providers, publically available information, or from the user that represent evaluation variables (any information that might be helpful for the analysis as it relates to the predicted variable.) The user may also choose to include additional information including, but not limited to, proprietary company information or subjective factors that he feels might be relevant to the analysis. The disclosed embodiments may analyze the information received by determining a correlation between the information received and evaluation variables. Evaluation variables may include demographic statistics, geographical statistics, business statistics and the like. By determining a correlation between a given evaluation variable and the predicted variable, the disclosed embodiments may determine a coefficient for the given evaluation variable. In this way, coefficients are determined for associated evaluation variables. A formula may be generated comprising the evaluation variables and associated coefficients. The disclosed embodiments may also analyze the significance of each evaluation variable and determine the influence that each given factor will have on the predicted variable. Therefore, by including additional factors/variables that might potentially be relevant, a user can optionally improve the accuracy of the disclosed embodiment's predictions by causing it to consider more possible alternatives.

The disclosed embodiments may receive a new business location. For example, a user may provide a proposed new business location by entering a street address. The disclosed embodiments may collect data relating to the new business location. The disclosed embodiments may apply the formula to the data in order to generate an output value for the predicted variable.

The disclosed embodiments may also identify locations within a region based on entered criteria. For example, a user of the disclosed embodiments (i.e., a user) may know a minimum amount of annual sales required to create a likelihood of success for a new business location. However, the user may not have a particular location in mind, but instead seeks to know what locations may exceed the minimum amount of annual sales.

The disclosed embodiments may also rank the most likely locations to succeed in a given region specified by the user based on the highest or lowest values of the predicted variable. For example, a user of the disclosed embodiments may wish to know the 10 most recommended locations in New York City based on predicted sales. The disclosed embodiments may apply the formula to the data for each potential area within the specified region and then rank each potential location in a given region to create this output.

The disclosed embodiments may search a region to determine if there are areas within the region where the output value of the predicted variable may satisfy entered criteria. The disclosed embodiments may collect data relating to the region. In addition, the disclosed embodiments may apply the formula to the data in order to generate output values for the predicted variable associated with different locations within the region. The disclosed embodiments may report locations to the user within the region that meet the user's criteria.

The disclosed embodiments may also provide assistance in evaluating decisions in general. A decision to be made may be evaluated by using information relating to similar previous decisions. The methods disclosed herein are equally applicable to such decision making (e.g., where a correlation may be established between evaluation variables and the decision).

### BRIEF DESCRIPTION OF THE DRAWINGS

FIG. 1 illustrates an exemplary computing environment.

FIG. 2 illustrates an exemplary scenario of a company seeking to open a new business location.

FIG. 3 illustrates an exemplary method that may indicate the value of a predicted variable for a new business location.

FIG. 4 illustrates an exemplary method through which new business locations may be suggested.

FIG. 5 illustrates an exemplary heat map.

### DETAILED DESCRIPTION

The detailed description that follows may refer to steps. However, the disclosed steps and associated methods are exemplary. The order of the steps may be varied where appropriate. In addition, steps may be omitted if not needed and additional steps may be added.

The disclosure below illustrates steps to evaluate a predicted variable that may be a proxy for success of a new business location. The present invention is not limited to business location analysis or evaluation, but rather has broad applicability. For example, the steps described herein may be employed to evaluate, analyze, or predict a wide range of decisions relating to location or other parameters. For merely a few of the many possible applications, the steps explained herein may be used to evaluate predicted variables associated with the location of parks, religious institutions, and other non-business entities; predicted variables associated with allocation of retail space, warehouse space, seating space, or other space requirements for existing or new business or non-business locations; whether to install escalators or elevators in a proposed building; how and where to allocate merchandise in a retail setting and any other predicted variables corresponding to additional uses that flow naturally from the present disclosure and as understood by persons familiar with logistics or siting.

A person or entity may seek to open a new business location. For example, a company may operate a similar business at several existing locations (e.g., supermarkets, department stores, chain stores, service chains, franchises, etc.). Further, the company may want to open a similar business at a new business location. The disclosed embodiments may provide information allowing the company to evaluate the likelihood of success of a similar business at the new location.

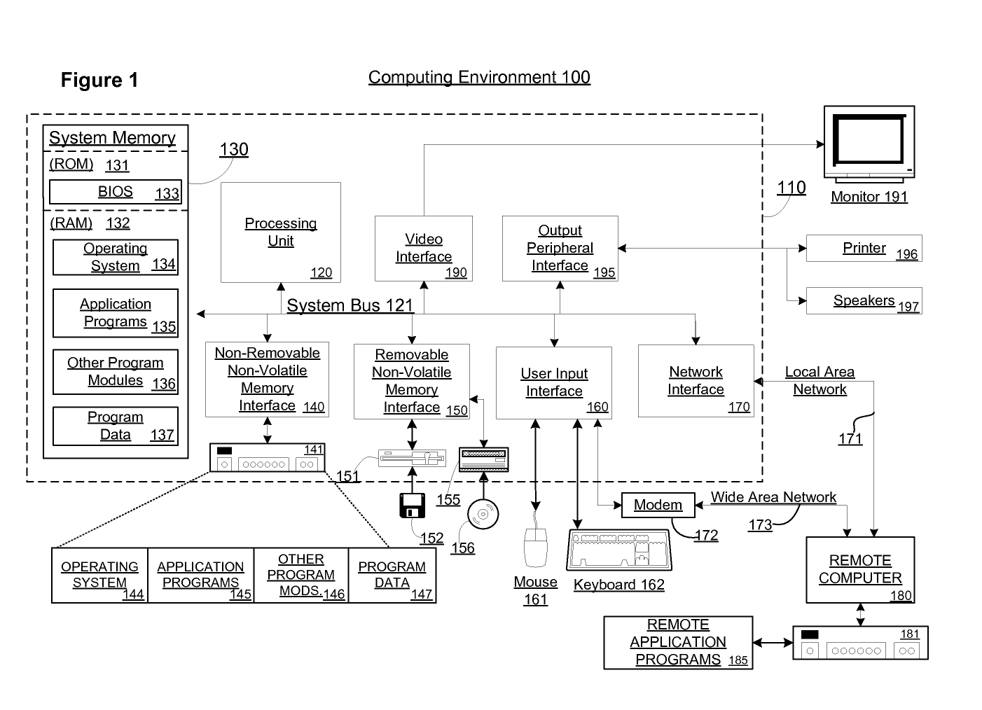

FIG. 1 illustrates an exemplary computing environment in which the disclosed embodiments may be implemented. The exemplary computing environment 100 includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in remote memory storage device 181. By way of example, and not limitation, FIG. 1 illustrates remote application programs 185 as residing on remote memory storage device 181. It may be appreciated that the network connections shown are exemplary and other means of establishing a communications link between the computers may be used.

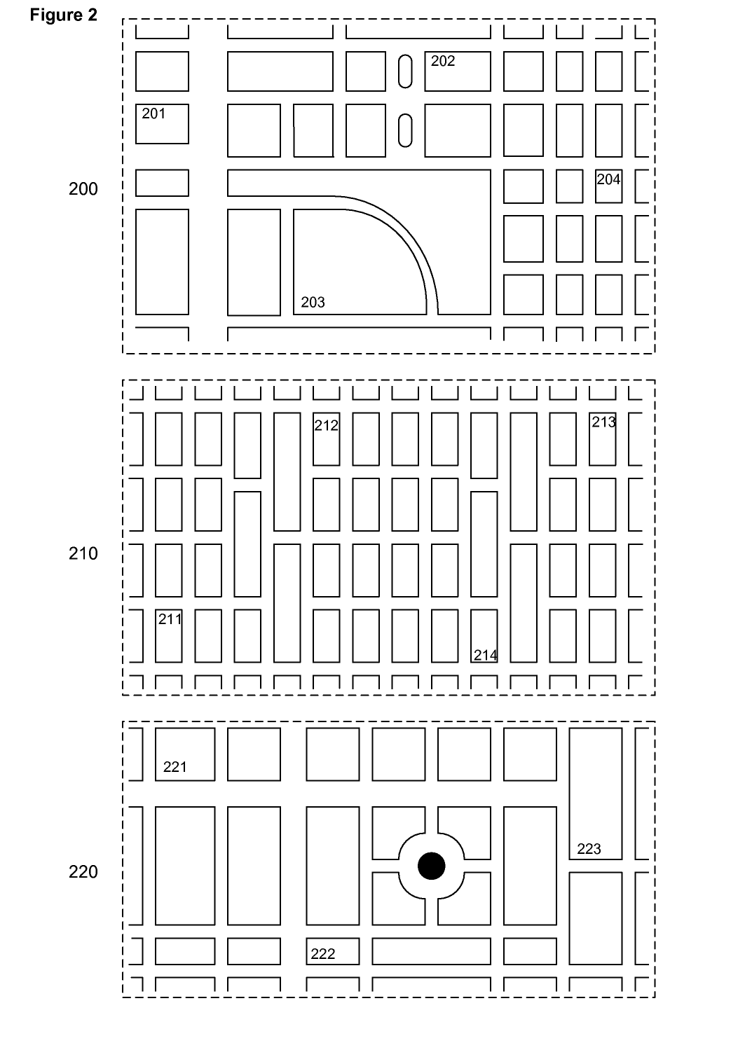

FIG. 2 illustrates an exemplary scenario of a company seeking to expand. A company may own widget stores at several locations in different cities. For example, the company may have existing business locations 201-204 in city 200 and existing business locations 211-214 in city 210. Further, the company may seek to expand operations by opening one or more new business location in city 220. The company may have identified potential business locations 221-223 as locations that meet the size requirements for a widget store and are available. The company may want to determine which of the potential business locations 221-223 may have the highest likelihood of success. Further, the company may want to evaluate whether the location with the highest likelihood of success may operate at a profit sought by the company.

The company may have information available for each of the existing business locations (i.e., existing business locations 201-204 and 211-214), such as annual sales, annual profit, traffic and the like. The company may seek to use the information for each of the existing business locations to evaluate the chances of success for potential business locations 221-223.

The disclosed embodiments may use information about existing business locations as a basis to predict the success of a new business location. For example, information may be received and collected about existing business locations, which may include information about locations, predicted variables and evaluation variables. A predicted variable may be a variable for which a user seeks a prediction. A predicted variable may include anything a user may seek to have predicted, such as “annual sales.” A user may provide information for annual sales at existing locations and seek a prediction of annual sales at a new business location. An evaluation variable may represent any parameter capable of being quantified, located or identified, such as a demographic statistic, a geographical statistic, a business statistic or the like. An evaluation variable may also consist of subjective or objective proprietary information provided by the user.

A relationship may be determined that provides a link between an evaluation variable and a predicted variable. The relationship may be determined by any mathematical method, including regression techniques and other statistical analysis methods.

A user may provide information about a new business location (e.g., a location that a user may want to evaluate). Data may be collected relating to the new business location, which may include collecting data for the previously determined statistically significant evaluation variables relating to the new business location.

An output value of the predicted variable may be determined. The output value of the predicted variable may be the value of the predicted variable for the new business location. The output value of the predicted variable may be generated by using the determined relationship between the evaluation variable and the predicted variable to generate an output value for the predicted variable for the new business location. The output value of the predicted variable may be used as a measure to predict success of the new business location.

For example, a business owner may set an estimate of $5,000,000 for annual sales at a new business location to justify the cost and risk of opening a store at the new business location. The business owner may use a prediction about the amount of annual sales at the new business location in order to help evaluate whether or not to open a store at the new business location.

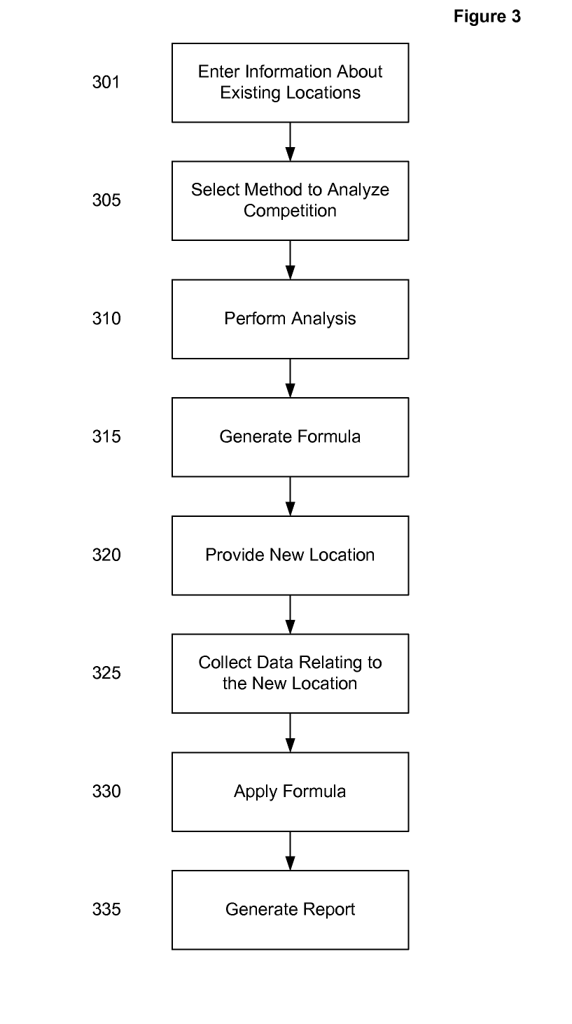

FIG. 3 illustrates an exemplary method that may predict one or more parameters for a new business location, where the predicted parameters may be used to evaluate the likelihood of success of a new business location. At 301, a user may enter information about existing business locations, which may include location and predicted variable information. The user may enter location information about each existing business location, such as a street address, shopping center, block, etc. In addition, the user may enter information relating to one or more predicted variables, such as sales, revenue, traffic, or the like.

As an example, a user may seek a prediction on the amount of annual sales at a new location (i.e., the amount of annual sales may be the predicted variable). The user may enter 123 Main Street, Anytown, N.Y. 00000 as an existing business location, along with the information that annual sales are $2,000,000.00 for the location. That is, the value of the predicted variable for the existing business location at 123 Main Street, Anytown, N.Y. 00000 is $2,000,000.00. The value of the predicted variable for an existing business location may also be referred to as an input value for the predicted variable. The user may enter information about multiple existing business locations, as well as input values for one or more predicted variables relating to each of the multiple existing business locations.

At 305, a user may select a method to analyze competition. For example, a user may select to analyze each location individually, analyze each location as a custom variable or assume competition from other variables.

At 310, statistical analysis may be performed analyzing the relationship between a predicted variable and evaluation variables. An evaluation variable may represent any parameter capable of being quantified, located or identified, such as a demographic statistic, a geographical statistic, a business statistic or the like. Exemplary evaluation variables may include demographic statistics such as the number of people aged 20-29 located within a defined radius or geographic boundary, the number of people with income of $50,000.00-$74,999.00 within walking distance of a location, the number of people with at least a bachelor's degree in a zip code, the average daily number of people that visit a specific location (e.g., by tracking cell phone signals, credit card records, etc.) or the like. Exemplary evaluation variables may also include geographical statistics such as highway entrance/exit points within a defined radius, how many parks are located in a town, whether there is a recreational body of water in a county or the like. In addition, exemplary evaluation variables may include business statistics such as the sales tax rate in a state, the number of industrial sites in a given radius, the number of restaurants within walking distance of a location, average hours of sunlight per day or the like. The number of evaluation variables may be infinite and may be limited by a system designer. A system designer may also choose to change the evaluation variable set for different industries or for any other reason.

The statistical analysis performed at 310 may be any statistical analysis that establishes any correlation or relationship between a predicted variable and evaluation variables. For example, a single evaluation variable may be varied while the other evaluation variables are held constant. By tracking the effect that varying the single evaluation variable has on the predicted variable, a coefficient may be determined for the single evaluation variable. The coefficient may be used to predict the effect of the single evaluation variable on the predicted variable for new locations. By repeating the analysis for multiple evaluation variables, a coefficient may be determined for each of the evaluation variables. Another potential statistical method that can be used is to examine the attributes of different customers at various existing locations in order to determine the number of potential customers in a given area by looking at overlapping characteristics based on evaluation variables. Then, once a number of total potential members is determined, a penetration rate can be calculated to make various predictions related to actual numbers (not potential.) For example, it may be determined based on existing locations and customers that a given business tends to attract customers over the age of 40, who work in the financial sector, and have at least 2 children and that in a given trade area for potential location there are 20,000 customers who fit this criteria. Then, based on the performance of existing locations, the disclosed embodiments may further determine that the new location will achieve a 5% penetration rate and that attract 1,000 customers which represent average monthly sales of $500 each. Various more sophisticated variations and additional methods including machine learning techniques may also be used to make predictions.

The accuracy of the disclosed embodiment's predictions may increase when more data is available to establish a correlation between a predicted variable and evaluation variables. That is, as more existing business locations are entered at 301, the value of the predictions may be more accurate. For example, the predictions may be more accurate when information is entered about 20 existing business locations as opposed to entering information about 5 existing business locations.

At 315, a formula may be generated with the evaluation variables and the calculated coefficients associated with the evaluation variables. The formula may be used to predict an output value for the predicted variable for a new business location.

An exemplary formula in a linear regression setup that may predict the number of members that may join a gym opened at a new location is:

Members=2.1297 (w)+1.0972 (x)+0.2729 (y)−627 (z)

w=number of people aged 20-29 located within 1 mile

x=number of people aged 30-39 located within 1 mile

y=number of people aged 40-49 located within 1 mile

z=recreational areas within a one mile radius

In the above equation “Members” is the predicted variable. The terms “w,” “x,” “y,” and “z” are evaluation variables. In addition, the number “2.1297” is the coefficient associated with evaluation variable “w,” “1.0972” is the coefficient associated with evaluation variable “x,” “0.2729” is the coefficient associated with evaluation variable “y,” and “−627” is the coefficient associated with evaluation variable “z.” Although simplistic, the above formula illustrates how the calculation of the coefficients contributes to determining an output value for the predicted variable.

At 320, a user may input a proposed new business location. For example, a user may provide an address or another location identifier such as the name of a shopping center, a block identifier or a block identifier with the further identifier of a part of a block, such as a corner or mid-street. Specific examples include 456 Market Street, Adjacentown, N.Y. 00001 for a specific address, Sunnyhill Shopping Center, Adjacentown, N.Y. 00001 for a shopping center and Block 12345, Adjacentown, N.Y. 00001 for a block.

At 325, data may be collected relating to the proposed new business location. The collected data may relate to the previously determined significant evaluation variables. At step 325, the information relating to the evaluation variables may be from publicly available data from any source, from data available from the user, from data available from the provider, from data available from a third-party, etc. For example, the US census is only published once every 10 years, however the disclosed embodiments may access data from third-party providers that update various evaluation variables annually. Additionally, a database like the “Yellow Pages” might be more up-to-date than an industry SIC code database. The disclosed embodiments may access publically available sources like the “Yellow Pages” for information that might potentially be significant.

For example, if one evaluation variable is the number of people aged 20-29 located within 1 mile of the proposed new business location, the data to determine the evaluation variable may be collected. Data collection may be performed through any appropriate method, including collecting data over the Internet through publicly available sources, such as census data. In addition, data collection may be performed by acquiring data from third party providers. Further, data collection may be performed by acquiring data from the party seeking an evaluation of the new business location.

At 330, the formula may be applied to the collected data. For example, the following data may have been collected relating to the proposed new business location:

| New York City? | Yes (1) |
|---|---|
| Number of people aged 20-29 located within 1 mile: | 10,000 |
| Number of people aged 30-39 located within 1 mile: | 9,000 |
| Number of people aged 40-49 located within 1 mile: | 8,000 |
| Number of recreational areas within a one mile radius: | 1 |

Using the exemplary equation illustrated in paragraph [0035], the application of the formula to the data may generate the following result:

Members=0.1729 (10,000)+0.0872 (9,000)+0.0372 (8,000)−627 (1)+1000 (1)

Thus, for the exemplary equation, the predicted number of members is 3,184.4.

At 335, a report may be generated. The report may indicate to the user the value(s) of the predicted variable(s) for the new business location. The value of a predicted variable for the new business location may also be referred to as the output value for the predicted variable. In the example of paragraph 0040, the number “3,184.4” is the value of the predicted variable “Members,” that is, “3,184.4” is the output value of the predicted variable for the new business location.

The report may also communicate other useful information to the user in order to help evaluate the likelihood of success of the new business location. For example, the report may compare the values of the predicted variable and evaluation variables of the new business location with one or more existing business locations.

The report may also include other information that may be helpful to a user. For example, information may be provided about a real estate agent associated with the new business location. Thus, the report may provide information for an agent that has property listed at (or near) the new business location or is knowledgeable about the new business location. The user may also select to notify retail brokers in a given area of their interest. Likewise, retail brokers in a given area may subscribe to receiving automatic notifications from the disclosed embodiments.

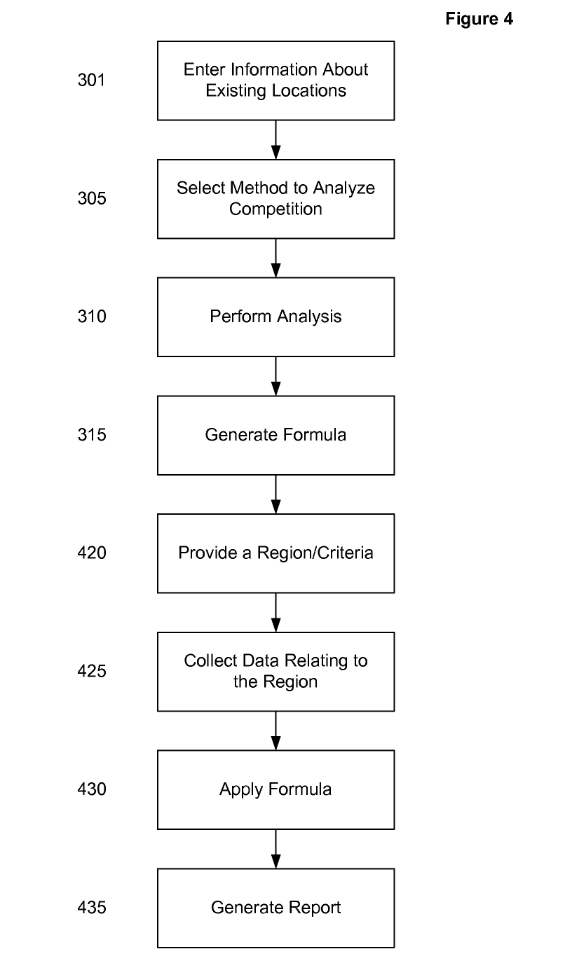

FIG. 4 illustrates an exemplary process through which new business locations maybe suggested. The process of FIG. 4 includes 301, 305, 310 and 315 from FIG. 3 and adds 420, 425, 430 and 435. At 420, a user may enter a proposed business region. A proposed business region may comprise any area. For convenience, the proposed business region may be defined to coincide with existing geographical boundaries. For example, a proposed business region may be defined as a country, a state, a zip code, a town, a city, a county, a multi-state region or any combination of the foregoing.

At 420, a user may also enter criteria by which the proposed business region may be analyzed. The criteria and method to analyze a proposed business region may be customized by a user in any appropriate manner. For example, a user may request that the location with the highest score for a predicted variable be reported (e.g., highest value for annual sales). A user may also request that a certain number of the highest scored locations be reported. The user may also establish criteria to be met in order to report a location. For example, a user may request that only locations with a minimum value for the predicted variable be reported. Further, a user may add other reporting criteria/filters. For example, a user may request that, in addition to the requirement that there be a minimum value of a predicted variable, there also be a minimum value for one or more evaluation variables. For example, a user may request that locations be suggested only if the value of annual sales is predicted to be over $10,000,000.00 and there are more than 10,000 people aged 20-29 living within one mile of the suggested new business location.

At 425, data is collected relating to the proposed business region. For example, if one evaluation variable is the number of people aged 20-29 located within 1 mile of a proposed new business location, the information may be gathered for the entire proposed business region specified at 420 and for 1 mile surrounding the proposed business region.

At 430, the formula may be applied to the collected data. An iterative process is one example illustrating applying the formula to data collected for a proposed business region. For example, the disclosed embodiments may iteratively calculate results for smaller and smaller geographic locations within the proposed business region in order to identify the best location or locations in the proposed business region.

At 435, a report may be generated. The report may provide information based on criteria entered by a user. For example, at 420, a user may have indicated that the top 10 locations be shown, where the top 10 locations are determined by the highest value of a predicted variable. In response, at 435, locations with the top 10 highest values for the predicted variable may be suggested to the user. The report generated at 435 may also include the information described in reference to FIG. 3 at 335 where appropriate.

The report may also include a heat map. A heat map may be used to convey information to the user in a pictorial format.

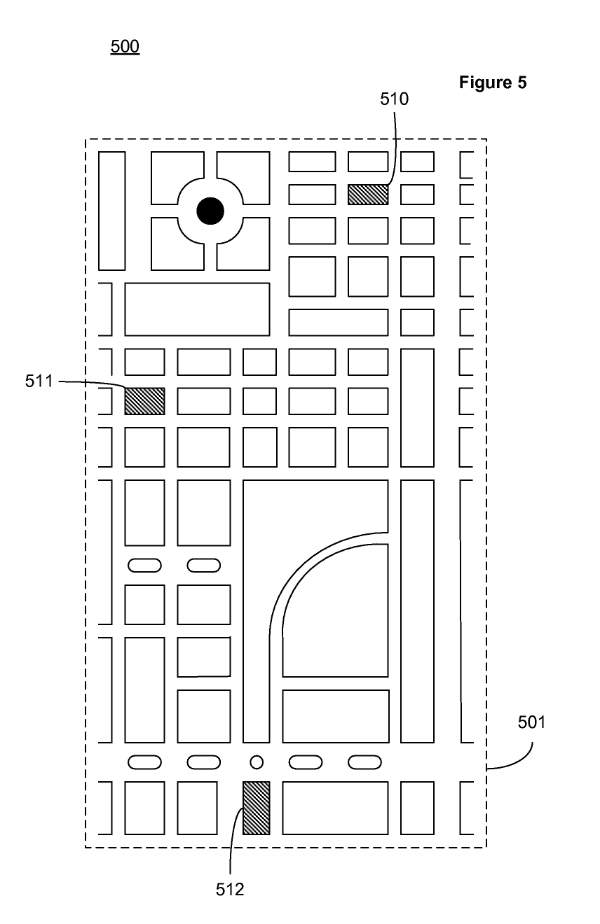

For example, FIG. 5 illustrates an exemplary heat map 500 for region 501. Heat map 500 may comprise a pictorial representation of a region entered by the user, at 420 of FIG. 4 for example. Heat map 500 may be used to pictorially illustrate recommended locations. For example, the heat map may illustrate the three new business locations in region 501 that have the highest projected annual sales, which may be used as an indication of a relative likelihood of success. Heat map 500 may thus show three recommended areas, represented by Recommended Location 510, Recommended Location 511 and Recommended Location 512, which may have the highest projected values for annual sales in region 501.

Heat map 500 may illustrate relative values of variables within region 501. For example, Recommended Locations 510-512 may each have different shading or coloring, which may be an indication of which location has the highest, second highest or third highest predicted annual sales. Further, any combination of shades, colors, etc., may be used to distinguish between variables and values to convey information to a user. A user may be able to interact with the map to choose the display or customize the display.

A custom variable is a user-defined evaluation variable. Although not limited to such applications, a custom variable may allow the use of information not generally available from public or private sources. For example, a system designer may not be able to automatically collect information relating to evaluation variables for categories such as the number of parking spaces at a movie theatre, the net floor area of a store, the number of workout machines in a gym and the like because the information may not be readily available. However, if a user has access to quantities for these variables and would like to use such variables, a user may create custom variables to take such information into account.

Custom variables may be used in determining the output value for the predicted variable (i.e., the value of the predicted variable for a new business location). For example, the user may be prompted to enter a custom variable. The user may enter information for the custom variable for existing locations as well as the new business location. For example, a user may want to enter a custom variable for store area, in square feet, for each of the existing stores and the new business location.

Custom variables may also comprise subjective variables. Subjective variables may be variables that have relative values defined by a user. Subjective variables may be, but are not limited to, variables that are difficult or impossible to mathematically quantify. For example, a user may want to take into account whether a location is trendy or how difficult it may be for customers to park at a location. Although these variables may be difficult or impossible to mathematically quantify, a user may be able to estimate relative degrees for the value of the variables.

Subjective variables may be given values of degree by a user. For example, a user may be able to rate the trendiness of a location, as compared to other locations, on a 1 to 10 scale. As another example, a user may be able to rate the ease of parking, as compared to other locations, on a 1 to 20 scale.

The disclosed embodiments may use any statistical method and information relating objective evaluation to variables to intuitively rate these quantities based on other information. This will limit the bias of the user and will, to some extent, objectify subjective variables. For example, the previously mentioned subjective variable “trendiness” is mentioned. The disclosed embodiments may attempt to intuitively and automatically apply trendiness ratings after a given number of ratings are assigned to existing locations. In this example, it is very possible that trendiness maybe highly related to age, income, traffic count, etc. After the user has subjectively assigned trendiness ratings to certain number of locations, the program will “learn” by employing statistical methods how to predict trendiness for the additional unassigned existing locations and new locations. Then, when evaluating a new location, the disclosed embodiments will automatically assign a rating for the subjective variable while still allowing the user to override the rating value.

Custom variables may be used to reduce the percentage error of the value of a predicted variable. By reducing the percentage error of the value of a predicted variable, the disclosed embodiments may reduce the error in evaluating a likelihood of success of a new business location because a user may use one or more predicted variables in an evaluation of likely success. Adding additional considerations like custom variables will likely only make the disclosed embodiments more accurate because an irrelevant factor can be deemed insignificant and be automatically excluded from the analysis.

Likewise, a user may continue to tweak the disclosed embodiments until he is satisfied with level of accuracy by adding additional custom variables. The accuracy of the disclosed embodiments can be determined by using existing locations as test subjects. For example, a company may have 20 existing locations, which may be referred to as existing locations 1-20. The company may seek information about annual sales (i.e., annual sales is the predicted variable) at a proposed new business location, which may be referred to as location 21. The company may enter information about 19 of the existing locations, locations 1-19 for example, with annual sales as the predicted variable. The company may determine the accuracy of the output value of the predicted variable by determining the value of predicted annual sales for location 20 with the actual annual sales for location 20. That is, the company already knows the annual sales at location 20 and can easily determine the accuracy of the output value of the predicted variable with the known value of sales at existing location 20.

The company may enter custom variables to try and reduce any error in the output value of the predicted variable. If the company is not satisfied with the accuracy of the output value of the predicted variable, the company may add custom variables and retest the accuracy of the output value of the predicted variable. For example, the company may have run a test for location 20 and determined that there was an 4% error in the output value of the predicted variable. The company may then have added several custom variables and determined that there was a 1% error in the output value of the predicted variable. By adding custom variables, a user may thus improve the accuracy of the output value of the predicted variable. Once a user is satisfied with the results of the custom variables on the predicted variable(s) for existing locations, the user may evaluate a new business location (i.e., use the disclosed systems and methods to generate output value(s) for predicted variable(s) for a new business location, which in turn may indicate a likelihood of success for the new business location).

The disclosed embodiments may take competition into account when determining the output value of a predicted variable. The disclosed embodiments may query a user to make a competition selection. A competition selection may specify how to analyze competition. For example, when making a competition selection, a user may select to analyze each location individually, analyze each location as a custom variable, assume competition from other variables, assume competition from an industry database, or the like. Some competition selections may require a user to input competition information (e.g., when analyzing each location individually or using the custom variable method as sometimes a user may better understand its competitors and the overlapping demographics better than any publically available information).

One method of analyzing competition is to use the custom variable process described in paragraphs 0053-0059. For example, when using the custom variable method, a user may define a competition variable and provide a relative value for the competition variable for each of the existing locations and the new business location. As described above the claimed embodiments may use these ratings in order to calculate the output value of the predicted variable.

Another method of analyzing competition is to individually rate competitors for each location and automatically create a subjective variable for each. When entering the location information for existing locations and a new business location, the disclosed embodiments may prompt the user for information for each location. For example, when entering location information for an existing location, the disclosed embodiments may display competitors in the region, from a database of industry competitors for example. The user may be able to customize the display, such as displaying only a certain number of nearby competitors, adjusting the area from which the competitors are gathered, or the like. The user may rate the displayed competitors, on a scale of 1-99 for example. Individually rating competitors may allow the disclosed embodiments to evaluate competition factors such as the source of competition, proximity and like factors. The disclosed embodiments may then, for example, in the same way as it interprets information inputted relating to subjective variables, begin to make inferences and assign value ratings to each competitor in the vicinity of an additional existing site or new potential site. The user will still have the ability to override the assume assigned values, which would then become additional information for the disclosed embodiments to take into account for future subjective inferences. For example, a fast food chain may begin to assign ratings to each fast food chain competitor near the first 20 locations that they are prompted (which will automatically be located in diversified geographic areas in order for the disclosed embodiments to be able to infer and assigned values more accurately to different competitors in different regions.) Then, if the user does not feel like continuing to input values for each competitor in the vicinity of additional existing location or new location, he may select to have the disclosed embodiments assign subjective values for him. The disclosed embodiments will do this by taking into account the user's previously assigned ratings as well as proximity of each competitor, specific industry SIC code, number of employees and revenue of a competitor at a particular location as well as other relevant factors including those relating to overlapping demographics and customers.

Competition may also be taken into account by assuming their incorporation into other existing variables. The disclosed embodiments may return an output value for a predicted variable based on the universe of evaluation variables. For example, the annual sales of an existing location is assumed to reflect the competition in the area of the existing location. When assuming that the evaluation variables inherently reflect competition, the user may not have to make a competition selection nor enter competition information.

Another method would be to assume a competition level for an existing or new location based on calculated competition ratings. For example, for a particular industry a provider or third party may offer competition ratings by area. In such a case, the disclosed embodiments may consider competition using the information from the provider or third party without the need for manual input of information from the user.

A user, such as a new company, may utilize the disclosed embodiments by using data obtained from another party (i.e., data supplied by a person or entity not associated with the user). For example, a business with few or no existing locations may utilize the disclosed embodiments by entering data for comparable businesses. The disclosed embodiment may allow exchange of information, including predicted variable information, between similar businesses, which may allow a user to more thoroughly populate information about existing locations. Such sharing of information may also include a provider allowing use of data collected from other users (e.g., a retail store may use data collected from other users relating to retail stores). Such sharing of information may be provided anonymously and confidentially. Such sharing may take place based on a user identifying entities that are similar to the user's entity.

A user may utilize such information, for example, when entering data at 301 as described for FIGS. 3 and 4. Thus, when entering information about existing business locations, a user may enter information relating to unassociated businesses if data relating to the performance of those business' locations are accessable to the user. The user may also sift through a list of similar businesses provided by the disclosed embodiments that represent other users willing to share their information and attempt to determine those that are most similar to his. Then, the disclosed embodiment will automatically enter the similar company's data into the necessary fields. Further, a user may test the usefulness of information from comparable businesses by observing how well the information helps predict values of a predicted variable for a user's actual location(s).

A specific example is an entrepreneur deciding to open a hardware store as a startup business and needs to decide where to open a first location for the new business. There is no information about existing locations owned by the entrepreneur because the hardware store is a startup business by the entrepreneur. Instead, the entrepreneur may enter information or select to populate his data by accessing information about unassociated hardware stores (i.e., hardware stores that have no ownership affiliation with the entrepreneur).

Further, the methods and systems described herein encompass saving information on site selection of businesses or other entities such that the information can be used for analyzing similar or analogous businesses or the like. For example, the selection of a site for the above entrepreneur's hardware store may benefit from data entered as part of a prior site selection analysis. In this regard, if a prior hardware store operator has used the methods and systems described herein for its site selection tasks, the information associated with the prior site selection task may be used in the entrepreneur's hardware store's analysis, including using the data for evaluation variables and correlation coefficients (that is, in the (optional) embodiments in which regression techniques are employed)and the like. Preferably, the information relating to the prior hardware store is scrubbed of data that would make it identified with its source and in this way made anonymous.

In addition to using information about closely related businesses, information may also be entered or accessed for other types of stores. For example, the entrepreneur may believe that the success of a paint store closely corresponds to the success of a hardware store. In such a case, the entrepreneur may enter or access information about paint stores or identify paint stores for use by the methods and systems described herein, as described in the preceding paragraph.

The disclosed embodiments may also be used by estimating information about existing businesses. For example, if a user can estimate information about businesses not owned by the user, such information may be used with the disclosed embodiments. As another example, a user may use information from business locations that are no longer operating or no longer associated with user.

The accuracy of the disclosed embodiments may vary depending on the accuracy of information provided. For example, if information entered relating to existing business locations is inaccurate, the error in the output value of the predicted variable for a new business location may be greater than if accurate information was entered.

The disclosed embodiments may identify evaluation variables for exclusion from analysis. The disclosed embodiments may be able to distinguish between evaluation variables, assigning a relative importance to an evaluation variable based on whether an evaluation variable is material to the calculation of a value of a predicted variable. By excluding non-material evaluation variables, the disclosed embodiments may make the process more efficient, less costly or both by making it so that the user has to purchase less data from a third-party provider.

For example, the number of evaluation variables used in determining a value for a predicted variable may be large. In addition, there may be a cost associated with an evaluation variable. For example, for each demographic statistic searched for a location, a fee may have to be paid to a third party provider of the demographic statistic. By eliminating non-material evaluation variables from the analysis, cost savings may be realized.

The disclosed embodiments may allow a provider to provide efficiency by allowing collection of data (or subsets of data) only from the provider's server. This way, the analysis to determine which variables are significant and helpful for making predictions can be determined before the point of sale at which point the user or provider would be required to purchase an additional license to the third-party data (if the user wish's to view and publish the data that the predictions are based upon.) It is possible that a user may choose to “trust” the prediction methodology and not purchase access to the data and evaluation variables to reduce the cost of the analyses.

The disclosed embodiments may be implemented by computer programs that may be stored on computer readable media, such as those illustrated in FIG. 1. However, the systems and methods provided herein cannot be construed as limited in any way to a particular computing architecture or operating system. Instead, the presently disclosed subject matter should not be limited to any single embodiment, but rather should be construed in breadth and scope in accordance with the appended claims.

What is claimed:

1. A method for evaluating a new business location, the method comprising:
receiving information relating to at least one existing business location, wherein the information comprises a predicted variable;
collecting information relating to an evaluation variable from either third-party providers, publically available information, or the user
determining a relationship between the evaluation variable and the predicted variable,
receiving a new business location;
collecting data relating to the new business location; and
determining an output value of the predicted variable for the new business location, wherein the output value of the predicted variable is used as a measure for evaluating the new business location, and wherein determining the output value of the predicted variable for the new business location comprises applying the relationship between the evaluation variable and the predicted variable to the data.

2. A method for evaluating a new business location, the method comprising:
receiving information relating to at least one existing business location, wherein the information comprises an input value for a predicted variable;
calculating a coefficient associated with an evaluation variable, wherein the coefficient is calculated based on a determination of a correlation between the evaluation variable and the predicted variable;
generating a formula, wherein the formula comprises the coefficient and associated evaluation variable;
receiving a new business location;
collecting data relating to the new business location; and
applying the formula to the data, wherein applying the formula to the data comprises:
determining a value for the evaluation variable from the collected data; and
calculating an output value for the predicted variable by applying the evaluation variable value to the coefficient, wherein the output value for the predicted variable is used as a measure for evaluating the new business location.

3. The method of claim 2, wherein calculating the coefficient comprises:
choosing a first evaluation variable and a second evaluation variable;
determining a relationship between the first evaluation variable and the predicted variable by varying a first value of the first evaluation variable while holding a second value of the second evaluation variable constant; and
determining the coefficient based on an effect that the varying of the first value has on the predicted variable.

4. The method of claim 2, further comprising identifying an unnecessary evaluation variable, wherein the unnecessary evaluation variable is excluded from at least one of: the formula or data collection.

5. The method of claim 2, further comprising receiving a competition selection, wherein the competition selection comprises at least one of the following: a selection to analyze each location individually or a selection to analyze each location as a custom variable.

6. The method of claim 2, wherein the evaluation variable comprises a custom variable.

7. The method of claim 6, wherein the custom variable comprises a subjective variable.

8. The method of claim 2, wherein the information relating to the at least one existing business location comprises data from other users.

9. The method of claim 2, further comprising generating a report in response to the application of the formula to the data, wherein the report includes at least one of: the output value for the predicted variable, a comparison of the new business location to the at least one existing business location or a referral to a real estate agent associated with the new business location.

10. A method for evaluating a new business location, the method comprising:
receiving information relating to at least one existing business location, wherein the information comprises an input value for a predicted variable;
calculating a coefficient associated with an evaluation variable, wherein the coefficient is calculated based on a determination of a correlation between the evaluation variable and the predicted variable;
generating a formula, wherein the formula comprises the coefficient and associated evaluation variable;
receiving a proposed business region;
collecting data relating to the proposed business region;
applying the formula to the data; and
generating a report in response to the application of the formula to the data, wherein the report includes at least one of the following: a suggested location, a comparison of the suggested location to the at least one existing business location or a heat map.

11. A method for evaluating a new business location, the method comprising:
providing information relating to at least one existing business location, wherein the information comprises an input value for a predicted variable;
providing at least one of: a new business location or a proposed business region; and
receiving a report, wherein the report comprises at least one of: an output value of a predicted variable, a suggested location, a comparison of the suggested location to the at least one existing business location or a heat map.

12. The method of claim 11, wherein the output value of the predicted variable is calculated by a method comprising:
calculating a coefficient associated with an evaluation variable, wherein the coefficient is calculated based on a determination of a correlation between the evaluation variable and the predicted variable;
generating a formula, wherein the formula comprises the coefficient and associated evaluation variable;
receiving a new business location;
collecting data relating to the new business location; and
applying the formula to the data, wherein applying the formula to the data comprises:
determining a value for the evaluation variable from the collected data; and
calculating an output value for the predicted variable by applying the evaluation variable value to the coefficient.

13. A computer-readable storage medium having stored thereon computer-readable instructions that, when executed by a computer, cause the computer to perform a process comprising:
receiving information relating to at least one existing business location, wherein the information comprises an input value for a predicted variable;
calculating a coefficient associated with an evaluation variable, wherein the coefficient is calculated based on a determination of a correlation between the evaluation variable and the predicted variable;
generating a formula, wherein the formula comprises the coefficient and associated evaluation variable;
receiving a new business location;
collecting data relating to the new business location; and
applying the formula to the data, wherein applying the formula to the data comprises:
determining a value for the evaluation variable from the collected data; and
calculating an output value for the predicted variable by applying the evaluation variable value to the coefficient, wherein the output value for the predicted variable is used as a measure for evaluating the new business location.

14. The computer-readable storage medium of claim 13, wherein calculating the coefficient comprises:
choosing a first evaluation variable and a second evaluation variable;
determining a relationship between the first evaluation variable and the predicted variable by varying a first value of the first evaluation variable while holding a second value of the second evaluation variable constant; and
determining the coefficient based on an effect that the varying of the first value has on the predicted variable.

15. The computer-readable storage medium of claim 13, wherein the process further comprises identifying an unnecessary evaluation variable, wherein the unnecessary evaluation variable is excluded from at least one of: the formula or data collection.

16. The computer-readable storage medium of claim 13, wherein the process further comprises receiving a competition selection, wherein the competition selection comprises at least one of the following: a selection to analyze each location individually or a selection to analyze each location as a custom variable.

17. The computer-readable storage medium of claim 13, wherein the evaluation variable comprises a custom variable.

18. The computer-readable storage medium of claim 17, wherein the custom variable comprises a subjective variable.

19. The computer-readable storage medium of claim 13, wherein the information relating to the at least one existing business location comprises at least one of the following: information about an associated business or information about an unassociated business.

20. The computer-readable storage medium of claim 13, wherein the process further comprises generating a report in response to the application of the formula to the data, wherein the report includes at least one of: the output value for the predicted variable, a comparison of the new business location to the at least one existing business location or a referral to a real estate agent associated with the new business location.

21. A computer-readable storage medium having stored thereon computer-readable instructions that, when executed by a computer, cause the computer to perform a process comprising:
receiving information relating to at least one existing business location, wherein the information comprises an input value for a predicted variable;
calculating a coefficient associated with an evaluation variable, wherein the coefficient is calculated based on a determination of a correlation between the evaluation variable and the predicted variable;
generating a formula, wherein the formula comprises the coefficient and associated evaluation variable;
receiving a proposed business region;
collecting data relating to the proposed business region;
applying the formula to the data; and
generating a report in response to the application of the formula to the data, wherein the report includes at least one of the following: a suggested location, a comparison of the suggested location to the at least one existing business location or a heat map.

22. A method for evaluating a decision, the method comprising the steps of:
receiving information relating to at least one previous decision that includes an input value associated with the at least one previous decision for a predicted variable, wherein the predicted variable is a proxy for success of the decision;
calculating a coefficient associated with an evaluation variable, wherein the coefficient is calculated based on a determination of a correlation between the evaluation variable and the predicted variable;
generating a formula, wherein the formula comprises the coefficient and the associated evaluation variable;
receiving the decision;
collecting data relating to the decision; and
applying the formula to the data, wherein applying the formula to the data comprises:
determining a value for the evaluation variable from the collected data; and
calculating an output value for the predicted variable by applying the evaluation variable value to the coefficient, wherein the output value for the predicted variable is used as a measure for evaluating the decision.
